(19) United States
(12) Patent Application Publication
(10) Pub. No.: US 2003/0000281 A1
(43) Pub. Date: Jan. 2, 2003

(54) Automatic gas sensor calibration system

(75) Inventors: Albert E. Ketler, Murrysville, PA (US); Bradley H. Baker, Monroeville, PA (US); Robert G. Poydence, Greensburg, PA (US); Lauren E. Sargent, Trafford, PA (US); Ronald C. Smathers, Ford City, PA (US)

Correspondence Address: BROWDY AND NEIMARK, P.L.L.C., 624 Ninth Street, N.W., Washington, DC, 20001, US

(73) Assignee: REL-TEK, MONROEVILLE, PA

(21) Appl. No.: 09/893,343

(22) Filed: Jun. 28, 2001

(51) Int. Cl. G01N 31/00; G01N 21/00

(52) U.S. Cl. 73/1.06

(57) ABSTRACT

An automatic system for calibrating gas sensors comprising a source of span gas and a source of zero gas, a means to control the flow of these gases to sensors. The system makes all required sensor value corrections and adjustments without human intervention.

### FIELD OF THE INVENTION

The present invention relates to a method and apparatus for automatically calibrating gas sensors.

### BACKGROUND OF THE INVENTION

Gas detectors protect life and property. In an industrial setting, gas detectors typically use remote sensors so that the presence of any hazardous gas, flammable, or toxic, may quickly be detected at a remote location of a facility or process. The presence of a hazardous gas is reported to a control room. The concentration of the gas is typically analyzed by computer, and alarms are automatically activated when the concentration of the gas exceeds certain preset values.

A major problem in any detection and alarm system is reliability. For the detection and alarm system to be safe, the operator must frequently check and calibrate each sensor. Calibration must be done quite frequently in order to insure the accuracy of the sensors. A large number of sensors are typically installed on a fixed gas detection site, so that calibration is an ongoing, time consuming process. Because sensors for a number of hazardous gases which are lighter than air, such as methane, hydrogen, etc. are sited high above the floor or ground, e.g., beneath the roofs of garages, inside skylights, inside silos, etc., applying calibration gas to these sensors to adjust the scaling can be hazardous to maintenance personnel.

One method for reducing the time, effort, and risk of calibrating sensors, which is usually performed monthly, was by “remote calibration”, or “rem-cal.” This entailed installing long ⅛ inch internal diameter tubes for delivering calibration gas directly to each sensor, using an adapter to direct the gas into the sensing head. Plastic tubing from each sensor led down to conveniently located calibration stations, usually mounted at eye level adjacent to the monitoring box. This type of monitoring box is described in Ketler, U.S. Pat. No. 66,169,488, the entire contents of which are hereby incorporated by reference. This monitoring box is also referred to as a Dxcalibar box. As many as 16 tubes, connecting to as many sensors, are organized into a terminal bracket such that each tube was labeled as to the particular sensor it served. Each tube also had its own hose barb adapter for easily applying gas from portable zero and span gas tanks to any selected sensor, via a flexible hose leading to a gas tank which is the source of the zero and span calibration gas.

The old style calibration process comprised applying zero gas (air) for about two minutes. The gas application time varied, depending upon the length of tubing, i.e., separation, between the sensor and the rem-cal station. The gas flowed through the tubing toward the sensors at about 100 feet per minute. A multimeter was used to monitor the analog electrical signal from the sensor, which was accessible inside the attending Dxcalibar box. When the zero setting became visibly stable, i.e., not changing with time, the technician adjusted the zero potentiometer on the remote calibration circuitry, also within the Dxcalibar box, so that the precise zero signal level, normally 4.00 ma, was viewed on a hand-held multi-meter. The zero gas was then turned off by a hand valve and then span (upscale) gas from the adjacent tank was applied for two minutes. Again, when the sensor stabilized at the high level condition, the span adjustment potentiometer was adjusted so that the signal read the proper gas concentration (e.g., 25 ppm carbon monoxide) as designated by the calibration certificate supplied with the calibration gas tank, presumably with accuracy traceable to the National Bureau of Standards.

Remote calibration, using tubes to route calibration gas to sensors offered major benefits in reduced time for calibration and safer working conditions for personnel. However, this process still required the use of a trained technician, and there was the possibility of errors occurring if the timing were cut short by a careless technician or if the meter readings and adjustments were imprecise. Indeed, if the pot adjustments were made prematurely, i.e., before the sensor signal stabilized, the result could be an improperly adjusted, inaccurate, sensor, which could note be relied upon to detect life threatening gas.

Traditionally, assuming 15 minutes of labor for manually calibrating only one sensor, a facility with 100 sensors could spend 300 worker-hours or more each year for monthly calibrations. Moreover, since sensors are usually sited in hard to reach places, the tedious and risky lifts and ladders needed to approach sensors for calibration are avoided, thus eliminating a safety hazard. Additionally, often vehicles or stored materials must be moved to gain physical access to the sensors.

### SUMMARY OF THE INVENTION

It is an object of the present invention to overcome the aforesaid deficiencies in the prior art.

It is another object of the present invention to provide a method for automatically calibrating gas sensors.

According to the present invention, two calibration gas tanks, one for zero gas and one for span gas, are sited adjacent to each remote calibration tube termination station. Calibration gas is automatically controlled using two computer controlled solenoid valves. The computer monitors the sensors and controls the on/off states of the two (zero and span gas) solenoid valves through existing conventional telemetry. The computer also makes all needed corrections and adjustments, all without human intervention. The extra cost of the dedicated gas tanks and solenoid control panel is quickly offset by the saving in human labor and, more importantly, by the extra safety afforded by eliminating human errors.

The sensors monitored by the system of the present invention need not all be of one type. For a mix of sensors, e.g., CO, CO₂, and CH₄, one set of tanks can be custom mixed to cover all three sensor types. Multiple calibration runs are programmed to cover all sensor types. The system of the present invention is capable or calibrating virtually any sensor array, whether in a cluster or strung out linearly, such as in a tunnel. Automatic calibration of tunnel sensors is particularly useful because of the inconvenience and high cost of diverting traffic while calibrating manually.

### BRIEF DESCRIPTION OF THE DRAWINGS

FIGS. 1A and 1B show a stationary version of the gas calibration system of the present invention.

FIG. 2 illustrates the parameters that can be programmed into the system of the present invention.

FIG. 3 shows additional detail of the stationary version of the system shown in FIG. 1.

FIG. 4 shows a portable gas calibration system of the present invention.

FIGS. 5A-5E illustrate details of the fittings for the gas calibration system.

FIG. 6 shows gas tubes leading to sensors for calibration.

FIGS. 7A-7F illustrate preparation of capillary holes in T barbs.

FIG. 8 illustrates the delivery of calibration gas to each sensor.

FIG. 9 illustrates delivery of calibration gas to each of 16 sensors.

### DETAILED DESCRIPTION OF THE INVENTION

AutoCal Description and Operation

The gas sensor calibration of the present invention, AutoCal (or “AC”), is controlled by AutoCal/SW software (or “AC/SW”,) a software program which runs on a PC under Windows-95, -98, -2000 or -NT. It operates in conjunction with Millennia-DX (or “M-DX”), a monitoring and control software package developed by Rel-Tek for data acquisition and alarm generation product programs used mainly in the mining and transit industries. AC/SW and M-DX “talk” back and forth, with AC/SW directing the AC procedure, while M-DX logs all data and communicates with the remote AC panel which interfaces with the cal-gas tanks and sensors.

AC/SW runs as a background task behind M-DX, timing its auto-calibration (or “ac”) event scheduling based on the PC's software calendar and clock. When calibration time is at hand, the AC/SW sends a message to M-DX—which is monitoring a large number of gas sensor signals for alarm conditions—to disable all alarms for all sensors connected to the AC panel which are to be calibrated. The AC/SW communicates to the AC panel at the field location near the sensors over a telemetry link to open the SPAN-gas solenoid valve. A pressure transducer at the remote panel monitors the gas pressure supply, the status of which is continuously telemetered to the computer. If the calibration gas pressure drops below a preset threshold, the AC/SW aborts the ac procedure and prints a message on the computer screen to notify the operator. If the pressure is sufficiently high, indicating ample gas supply, the ac procedure continues, with the upscale span calibration gas (usually a gas concentration of 50% of the full scale range of the sensor) flowing through the manifold of flow restricting orifices , then through the connected tubing, arriving at each sensor, and then entering each sensor's gas detection module. Following a timed duration, or whenever the farthest sensors are determined by the computer to have stabilized at the span calibration gas value, the computer sets the new span value in its digital calibration data bank to precisely the value of the span calibration gas concentration, usually within 12-bit resolution (i.e. +/−0.024% of the sensor range.) The computer then issues control commands to the AC panel to shut off the span solenoid and open the ZERO-gas solenoid valve. Again the gas pressure is verified to be sufficient, before progressing. The ZERO-gas (i.e. gas having no upscale component) flows through the manifold of orifices and tubing, pushing ahead of it any SPAN-gas remaining in the tubing, and finally arriving at the sensor. After a timed period, or whenever the zero level is determined to be stable, the computer proceeds to set the zero values in its digital data bank to the same 12-bit resolution. Should the calibration gas pressure fall below the preset minimum during any portion of the forgoing procedure, the entire AC event is aborted, a failure report is generated, and sensors are returned to their pre-test status. To terminate the AC procedure, the AC/SW notifies the M-DX to send a command to the AC panel to shut off the ZERO-gas solenoid valve. The computer then returns the newly calibrated sensors to their normal operational status, and the alarming functions are reactivated.

The computer generates a final report stating the results of the auto-calibration event, including the time and date, the span and zero values for each sensor before and after gases were applied, and listing any sensors which tested badly (i.e, which did . not demonstrate the expected movement between span and zero, or which were unstable.) Failed sensors are automatically disabled (i.e. removed from gas alarming service) and are flagged in the final report for special maintenance attention.

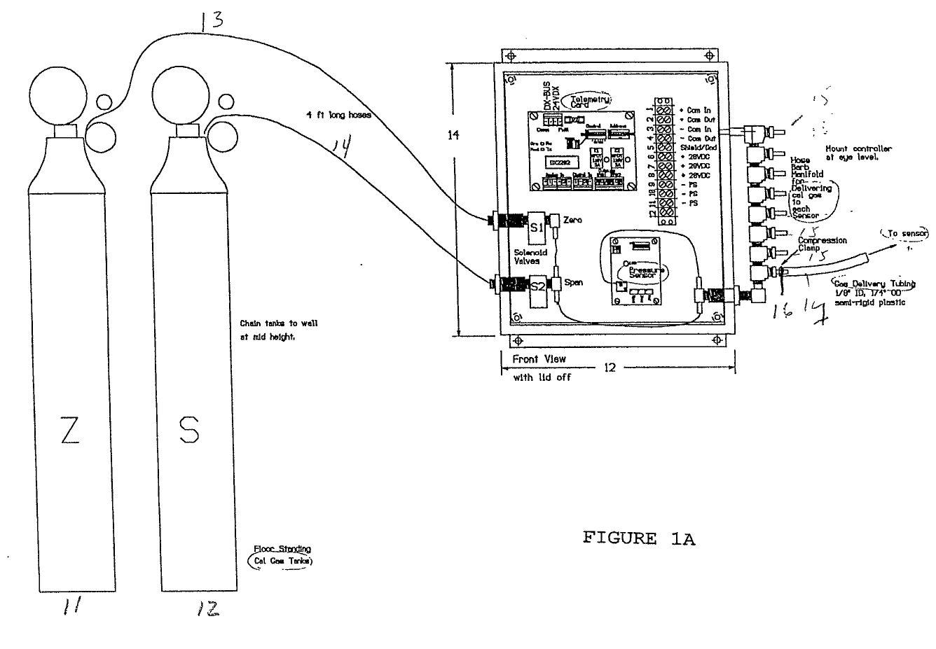

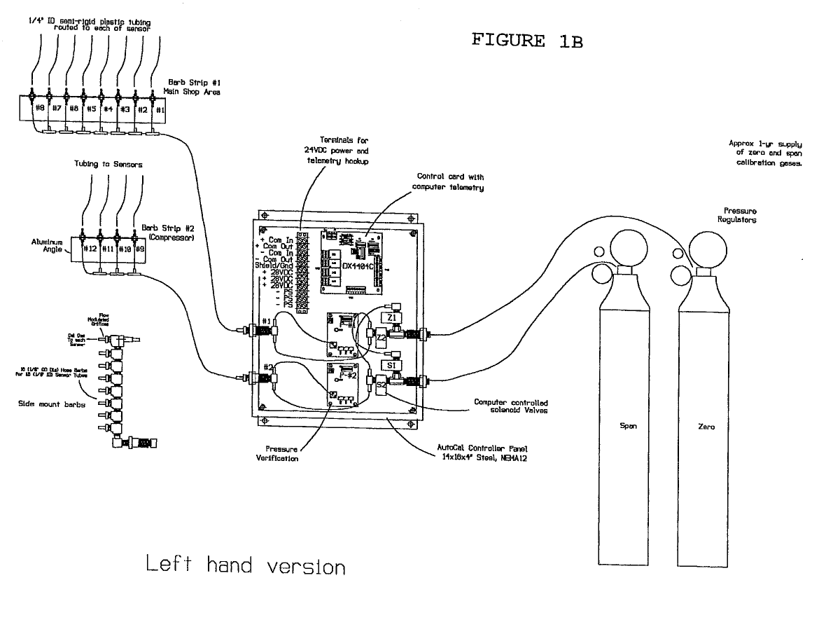

A real time graphical display of the progress of the AC procedure is available in M-DX software graphics. This depicts the values and trends of up to 16 sensors at a time, indicating the transient changes and stabilization of each sensor for viewing by management. Graphs may be printed out for hard copy reference. Also, the AC test data of all sensors is logged to hard drive throughout the procedure, so this historical information is available for offline viewing and printout. An 8-sensor auto-calibration graphic is shown in FIG. 1. This depicts eight purposely decalibrated sensors, tracking through a complete AC procedure—SPAN followed by ZERO gas delivery and computer adjustments. An immediate rerun—not part of the AC procedure—is shown to prove the calibration effectiveness of the forgoing AC procedure, wherein all eight previously processed sensors reach precisely the same SPAN and ZERO levels, albeit through differing transient paths, and thus requiring no further adjustments.

It is important that the span testing be done first, followed by the zero testing; as it is better to leave the gas supply tubing filled with ZERO-gas after test than with upscale SPAN-gas, the latter requiring purging, thus a second and wasteful usage of ZERO-gas. Performing span testing first and zero testing last leaves the tubing nicely purged with ZERO-gas at the end of the test.

Timed periods for each gas component flow (whether 8, 16 or more sensors are involved) is typically 10 minutes, although this depends on the length of cal-gas delivery tubing involved (approximately 100 ft per minute flow rate) and the response speed of the sensor under test. A complete AC procedure with 200 ft sensor ranges can take about 20 minutes.

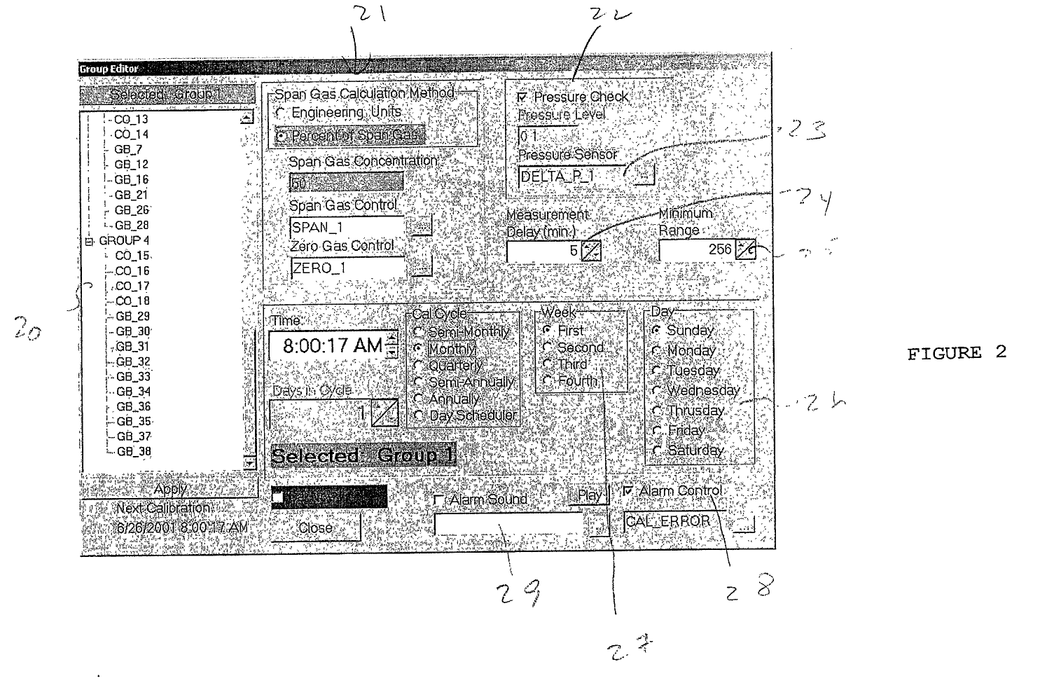

AC scheduling can be flexibly programmed to occur at virtually any time of calendar day, see FIG. 2. Multiple groups can be identified to be processed at different times. Pressure threshold can be entered, as well as the gas flow time and gas concentration parameters. In the event the user wishes to run an immediate recalibration—as following sensor replacement or an alarm incident—the “Cal Now” button can be selected which will start the AC procedure immediately.

The gas sensor calibration system of the present invention uses off the shelf software designed for gas calibration to control the entire calibration process. The software automatically turns calibration gas on and off to groups of sensors at predetermined intervals. The adjustments are then made at the computer, not at the sensor. If the sensor cannot be calibrated, the system alerts the user to permit further investigation of the cause of the problem.

In a typical arrangement, such as a bus maintenance facility, 32 carbon monoxide sensors are sited throughout the facility and electrically monitored in a conventional manner. Two 16 channel Dxcalibar boxes and two 16-channel AutoCal control stations, complete with calibration gas tanks, tubing, and a PC running the software are also provided.

When the automatic calibration system of the present invention is run, the computer temporarily disconnects the sensors form the alarms and plant controls and then precisely orchestrates the admission of zero and span calibration gas to individual sensors or to groups of sensors. Calibration gas stored in two pressure tanks and controlled by solenoid vales is directed through tubing leading form the safe ground level calibration station to the sensors, which can be up to or more than about 150 feet away in hazardous locations. Digital communication with the computer assures proper flow and calibration adjustments, and then generates full documentation for records.

The system of the present invention provides automatic scheduling and documentation, which saves time and effort while providing the information needed. Each sensor is regularly tested for proper operation, providing confidence that the gas detection system is operating properly. Bad sensors are identified and reported.

The Figures show a typical AutoCal equipment arrangement, but these examples are for illustrative purposes only and are not mean to be limiting. Sensors are not shown in the Figures, but are sited throughout the facility. A calibration gas tube is connected to each sensor using a permanently installed adapter fitting which directs any calibration gas flowing through the tube directly into the sensing head of the sensor.

FIGS. 1A and 1B illustrate a stationary version of the automatic calibration system of the present invention. FIG. 1A is the right hand version and FIG. 1B is the left hand version. Two calibration gas tanks, 11, 12, for zero gas and span gas, respectively are secured to a wall. Hoses, 13, 14, connect the tanks to solenoid valves, S1 and S2. In this illustration, the zero gas tank is connected to valve S1, and the span gas tank is connected to valve S2. Zero gas and span gas are fed through the solenoid valves to a plurality of hose barb manifolds 15 for delivering calibration gas to each sensor. A compression clamp 16 is provided to clamp the gas delivery tubing 17 to the hose barb manifold 15.

FIG. 2 shows the arrangement of FIG. 1 in greater detail. A pressure sensor 21 senses pressure in the calibration gases from the solenoid valves S1 and S2 to the hose barb manifolds 15. This pressure sensor is preferably equipped with an LED or other device that indicates when the pressure sensor is operational.

As shown in FIG. 2, the display 20 can include a mixture of several types of sensors in the groups. In this illustration, CO=carbon monoxide, and GB=methane. Other types of hazardous gases, of course, can be monitored by this system. While the Figure shows two groups, any number of groups can be used.

Section 21 of FIG. 2 identifies the calibration gas concentration. The pressure check 22 defines the pressure test and level for aborting. The pressure sensor 23 identifies the particular gas to be used in the pressure test. The measurement delay 24 shows the time lapse for zero and span gas flow. The minimum range 25 shows the minimum sensor movement to zero. Any day of the week can be chosen for the test to be run, as shown at 26, as well as the week of the month 27.

The alarm control display 28 defines whether an error message is to be displayed on the screen if a failure occurs. A silent audio alarm 29 is provided for notification of a failures; this can play a warning signal over a loudspeaker. A day scheduler for automatic calibration can be set to allow for a predetermined number of days between automatic calibrations.

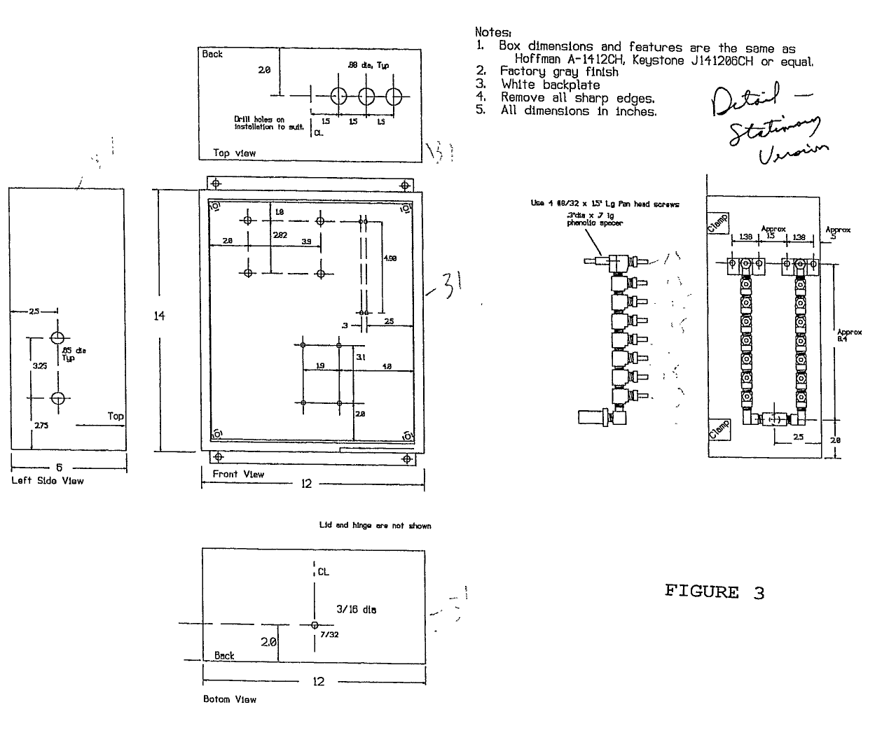

FIG. 3 illustrates a box 31 in which the hose barbs 15 are maintained.

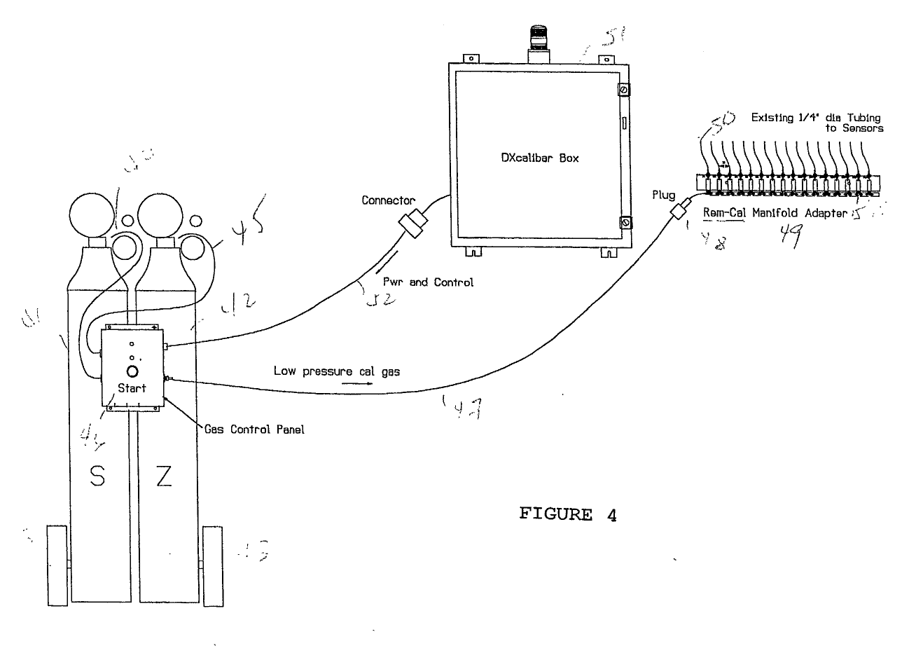

FIG. 4 shows a portable automatic calibration system wherein the gas tanks, 41 and 42, are installed on a cart with wheels 43 so that the tanks can be wheeled to any desired location. Hoses 44, 45, connect the span gas tank 41 and the zero gas tank 42 to a gas control panel 46. Low pressure calibration gas is fed through tube 47 to a manifold adapter 48 containing hose barb manifolds, 15. Tubing 50 carries the calibration gas to remotely located sensors. Power and control come from a Dxcalibar box 51 to the gas control panel 46.

A companion computer program in the central monitoring PC contains software for implementing and documenting the Automatic Calibration (Auto Cal) procedure. On a scheduled time and date, the computer invokes the auto cal procedure, logically disconnecting the alarm functions for the sensors, and commencing by introducing span gas into the sensor calibration tubing manifold. The software provides for a prescribed waiting time, generally on the order of two to three minutes, for the gas to travel the 100 feet or so to each sensor, and for the sensors to register the span gas value in a stable fashion. The computer then detects the raw digital value being transmitted to each sensor and assigns the calibrated values to the proper sensor configuration registers. After a time out period, the computer then terminates the span gas flow and opens the zero gas flow into the manifold.

There is another prescribed wait time for the zero gas to traverse the distance and register on the sensor. After that the computer assigns the calibrated zero values to the sensor registers and turns off the calibration gas flow, thus completing the calibration process. Once the calibration process is completed, the PC documents the time and date of calibration, along with any unusual changes or problems that were detected, in a calibration report.

The hose barbs on the calibration gas manifold contain flow restrictions, which is essential to provide equal flow over all 16 tubes. Without these flow restrictions, a tube with the least flow resistance will receive excess calibration gas, while a tube with a higher flow resistance will receive less gas flow. Since the gas flow and sensor output stabilizing time period is identical for all sensors, the sensor having the least flow may be inadequately stabilized at the end time when the sensor signal values are accepted. This would result in inaccurate calibration and possibly create an unsafe condition. Alternatively, the time period would have to be extended to provide sufficient stabilization time for the slowest, or highest resistance, path. This problem is solved by the present invention by providing passive, constant flow orifices in each path, such that the variable portion of the resistance, i.e., sensor to sensor, would be an insignificant variation when the constant resistance and variable resistance are combined.

The present invention provides an inexpensive way of implementing flow resistance inexpensively. Each hose barb on the flow manifold has a blockage with a tiny capillary hole (e.g., about 0.010 inch in diameter) installed. Several methods can be used to implement this capillary blockage, including potting shut and drilling. The preferred method is to embed a 0.010 inch diameter wire in a drop of epoxy or other similar material placed in the barb fitting. The fitting is held with the thin, open end downward, and the liquid resin forms a bubble at the low opening of the barb, The protruding portion of the wire and resin bubble are ground off, and then the wire is extracted, leaving behind a precise capillary orifice of the 0.010 inch wire diameter. This technique can be used for T barbs as well as straight through barbs, although installing the wire with a right angle pull through is somewhat tedious.

The backpressure created by the capillary hose barb, when wall mounted in a 16 barb wide manifold, created and maintained a near equal and constant flow of calibration gas to each of the 16 sensors when calibrated simultaneously.

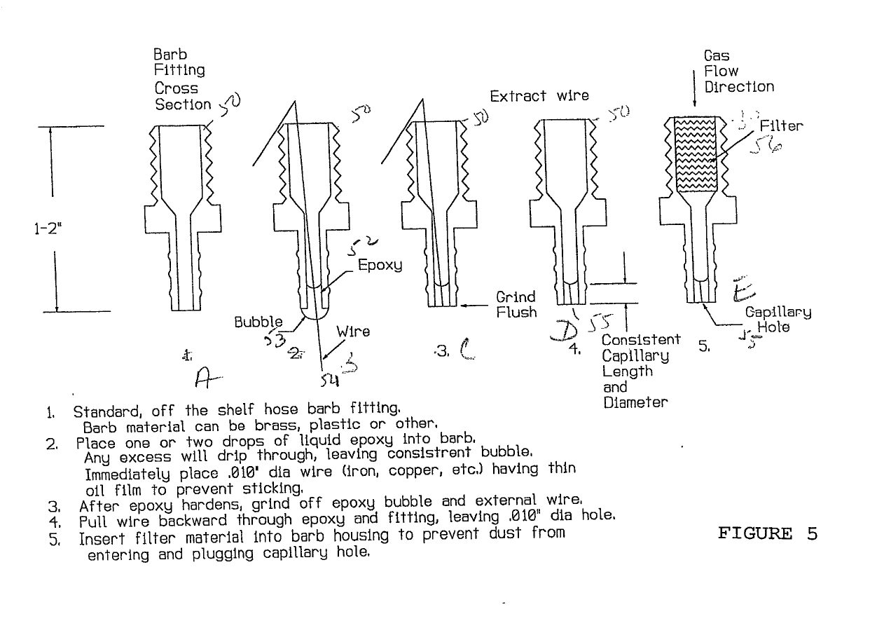

FIG. 5 illustrates the hose barb fittings and how they are prepared. FIG. 5A shows a standard, off the shelf hose barb fitting. The barb fitting can be made of any suitable material, such as brass, plastic, or the like. To prepare the capillary hole in the barb, one or two drops of liquid resin, such as epoxy, are placed into the top of the barb. Any excess resin drips though the barb, leaving a bubble 53 at the bottom. A wire 54 having the desired dimensions of the capillary hole is immediately placed through the barb and the bubble. The wire can be made of any relatively rigid material, such as iron, copper, and the like. A thin film of lubricant is preferably applied to the wire to prevent its sticking to the resin.

After the resin has hardened, the epoxy bubble and external wire are ground flush, as shown in FIG. 5C. The wire is extracted as shown in FIG. 5D, leaving a hole having a consistent capillary length and diameter 55. Filter material 56 is preferably inserted into the barb housing to prevent dust from entering and plugging the capillary hole, shown in FIG. 5E.

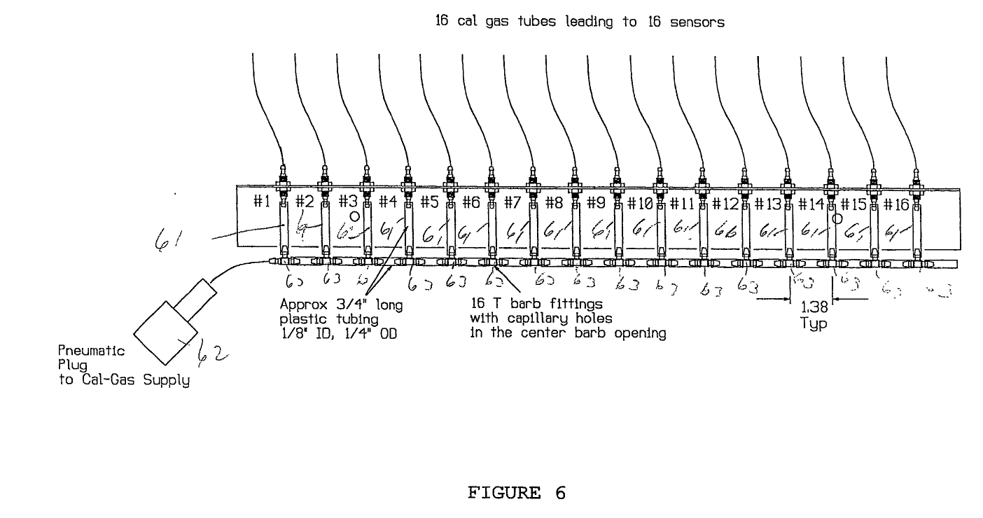

FIG. 6 illustrates 16 calibrating gas tubes 61 made of plastic or other suitable material. In this illustration, the tubes are approximately ¾ inch long with an internal diameter of ⅛ inch. Of course, the size of the tubing is not crucial to the present invention and is provided merely by way of illustration. A pneumatic plug 62 leads to the supply of calibration gas. Each calibration gas tube 61 is equipped with a T barb fitting 63 with a capillary hole in the center barb opening.

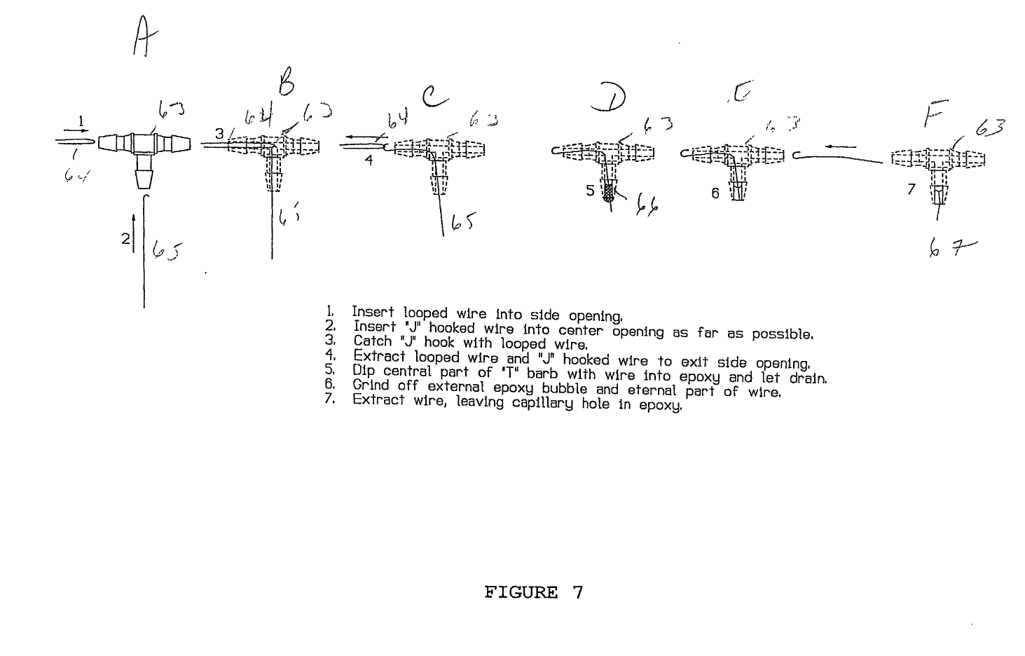

These T barb fittings can be conventionally available T barb fittings which have been provided with a capillary hole in the center barb opening. FIGS. 7A-7F illustrate one embodiment for forming a capillary opening in a T barb. As shown in FIG. 7A, a looped wire 64 is inserted into a side opening of the T barb 63. FIG. 7B shows inserting a “J” hooked wire into the center opening of the T barb 63 as far as possible. The looped wire catches the “J” hook as shown in FIG. 7C, and the looped wire and “J” hooked wire are extracted to that they both exit the side opening of the T barb 63. The central part of the T barb containing the wire is then dipped into a liquid resin such as epoxy and the resin drained, leaving a bubble of resin 66. The external bubble is ground off to form a T-barb as shown in FIG. 7E, The wire is then extracted, leaving a capillary hole 67 in the resin.

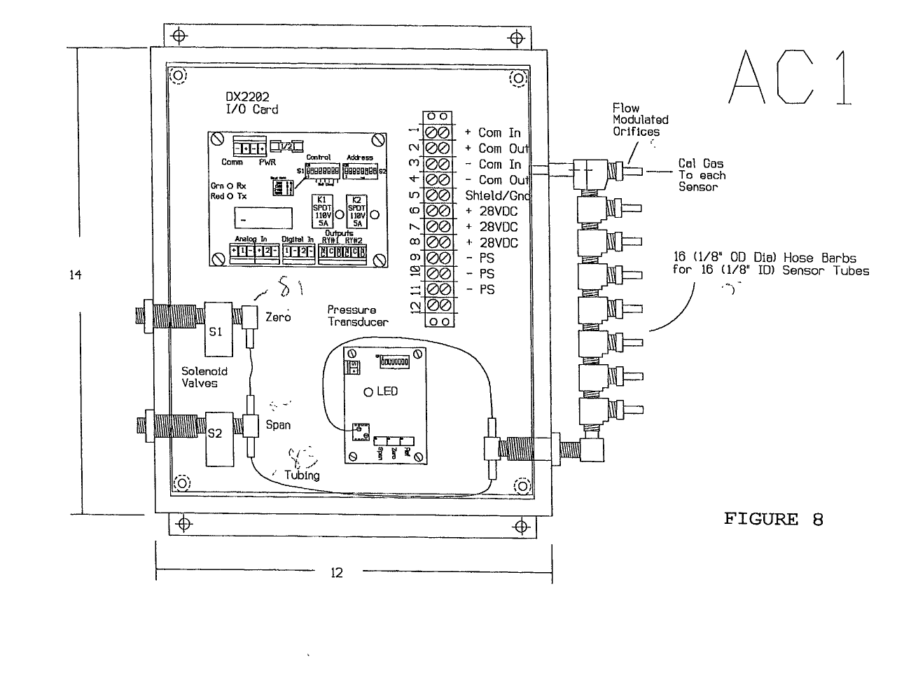

FIG. 8 illustrates delivery of calibration gas to sensors. Solenoid valves S1 and S2 control the flow of zero 81 and span 82 gas to tubing 83 which delivers the gases to flow modulated orifices 84, through which the calibration gas flows to each sensor. In this illustration, there are 16 hose barbs 85 for 16 sensor tubes.

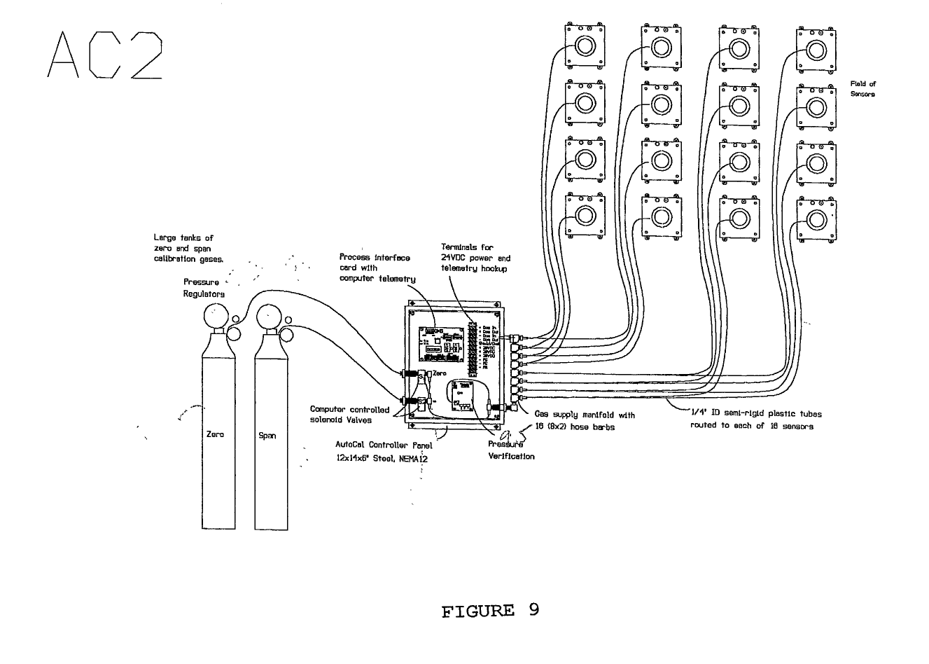

FIG. 9 includes large tanks of zero 91 and span 92 calibration gases, each of which is equipped with a pressure regulator 93. The gases pass through computer controlled solenoid valves 94, through a pressure verification 95, and then through a gas supply manifold 96 fitted with 16 hose barbs. Semi-rigid plastic tubes 97 carry the gas to each of 16 sensors 98.

Automatic calibration eliminates the costly technical labor and the inevitable human errors of manual calibration, wherein the sensors may not be fully stabilized when calibration adjustments are made, and where sensor adjustments can be anything but precise. Or, as frequently occurs, troublesome false alarms are activated during calibration, because the calibrating personnel failed to disable them properly prior to starting the tests. Automatic calibration takes care of all these eventualities without human concern. Using gas delivery tubing to each sensor eliminates the risk of sending personnel to the remote sensor locations which may be high overhead , inside a silo, above moving conveyors, or the like. AC can be scheduled for weekend and night hours (unfavorable for personnel) to avoid having to disable essential gas alarming functions during critical production times. AC performs automatically, so there is never a missed calibration event—and attending fines—where federal/state safety or environmental codes are involved. AC provides reliable documentation of the AC results as a verification of sensor conditions and calibration parameters encountered for archival records which can be made available for inspection if ever needed. AC uses large tanks of calibration gas, typically sufficient for a year of monthly or even weekly calibrations, thus avoiding the inconvenient depletion and frequent reordering of costlier, portable tanks used for manual calibration. The initial cost of AC is incidental compared with the savings in labor and other costs associated with manual calibration, usually paying back its investment in less than a year's time.

The foregoing description of the specific embodiments will so fully reveal the general nature of the invention that others can, by applying current knowledge, readily modify and/or adapt for various applications such specific embodiments without undue experimentation and without departing from the generic concept. Therefore, such adaptations and modifications should and are intended to be comprehended within the meaning and range of equivalents of the disclosed embodiments. It is to be understood that the phraseology or terminology employed herein is for the purpose of description and not of limitation. The means and materials for carrying our various disclosed functions may take a variety of alternative forms without departing from the invention. Thus, the expressions “means to . . . ” and “means for . . . ” as may be found in the specification above and/or in the claims below, followed by a functional statement, are intended to define and cover whatever structural, physical, chemical, or electrical element or structures which may now or in the future exist for carrying out the recited function, whether or not precisely equivalent to the embodiment or embodiments disclosed in the specification above; and it is intended that such expressions be given their broadest interpretation.

What is claimed is:

1. A process for automatically calibrating gas sensors comprising:
connecting a calibrating gas tube to teach sensor;
introducing span gas into the sensor calibration tube manifold;
waiting a predetermined time for the span gas to travel to each sensor and for the sensors to register the span gas in a stable fashion;
detecting the raw digital value being transmitted for each sensor and assigning the calibrated values to the proper sensor configuration registers;
terminating the span gas flow;
introducing zero gas into the sensor calibrating tube manifold;
waiting a predetermined time for the zero gas to travel to each sensor and for the sensors to register the zero gas in a stable fashion;
assigning calibrated zero values to the sensor registers;
turning of the zero gas flow.

2. The method according to claim 1 including, prior to executing the calibration process, disconnecting alarm functions for the sensors and, after the calibration process has been executed, reactivating the alarm functions for the sensors.

3. The method according to claim 1 wherein a computer monitors the sensors and controls the on/off states of the zero gas and the span gas .

4. The method according to claim 3 wherein the flow of zero gas and the span gas is controlled by a computer-controlled solenoid valve.

5. The method according to claim 3 wherein the computer generates a report after the calibration process is completed.

6. The method according to claim 1 wherein each sensor includes a permanently installed adapted fitting which directs any calibration gas flowing through the tube directly into a sensing head of the sensor.

7. The method according to claim 6 wherein the adapter is a hose barb containing a flow restriction.

8. The method according to claim 7 wherein the flow restriction comprises a blockage with a capillary hole installed.

9. The method according to claim 1 wherein a plurality of types of sensors are calibrated.

10. Apparatus for automatically calibrating gas sensors comprising:
a calibration gas tube connected to each sensor;
a source of span gas and a source of zero gas;
means to control introduction and termination of span gas and zero gas to each sensor.

11. The apparatus according to claim 10 wherein each sensor includes a permanently installed adapted fitting which directs any calibration gas flowing through the tube directly into the sensing head of the sensor.

12. The method according to claim 11 wherein the fitting includes flow restriction.

13. The method according to claim 12 wherein the flow restriction comprises a blockage with a capillary hole installed.

14. The apparatus according to claim 10 wherein the means to control introduction and termination of span gas and zero gas to each sensor comprises a computer.

15. The apparatus according to claim 10 wherein the introduction of span gas and zero gas is controlled by a computer and the span gas and the zero gas are introduced through solenoid valves.
